(19) United States
(12) Patent Application Publication
(10) Pub. No.: US 2015/0046247 A1
(43) Pub. Date: Feb. 12, 2015

(54) Methods and Systems for Computer Application Incentivization Based on Reduced Advertisement

(71) Applicant: Zynga Inc., San Francisco, CA (US)

(72) Inventor: Vishwanath Rajappa, Santa Clara, CA (US)

(73) Assignee: Zynga Inc., San Francisco, CA (US)

(21) Appl. No.: 13/961,804

(22) Filed: Aug. 7, 2013

(51) Int. Cl. G06Q 30/02

(52) U.S. Cl. CPC G06Q 30/0235
USPC 705/14.35

(57) ABSTRACT

A notification of requirements to earn a reduced-ad reward is provided to a user of an ad-associated computer application (app). Actions of the user are monitored to determine whether or not requirements to earn the reduced-ad reward are satisfied by the user. Upon determining that requirements to earn the reduced-ad reward are satisfied by the user, the reduced-ad reward is provided to the user of the ad-associated app. The reduced-ad reward is a specified amount of time in which the user can execute a reduced-ad version of the ad-associated app without monetary cost to the user.

### BACKGROUND

Selling of advertisement (ad) space and presentation of corresponding ads in conjunction with a computer application (app), such as a video game, mobile app, or web app, is a component of the app monetization process or a component of the app product flow without regard to monetization. In some cases, selling and presentation of ads is limited to free versions of a given app, with the paid version of the given app being provided without ads. Therefore, a user executing the free version of the app must accept the inconvenience, to whatever extent it exists, associated with the displaying of ads within or in conjunction with the app. If the user desires to execute the app without the inconvenience of displayed ads, the user must pay to install the paid version of the app. It is within this context that the present invention arises.

### SUMMARY

In one embodiment, a computer implemented method for executing a computer application (app) is disclosed. The method includes providing a notification of requirements to earn a reduced-ad reward to a user of an ad-associated app. The method also includes receiving data of monitored actions of the user to determine whether or not requirements to earn the reduced-ad reward are satisfied by the user. The method further includes providing the reduced-ad reward to the user of the ad-associated app upon determining that requirements to earn the reduced-ad reward are satisfied by the user. The reduced-ad reward is a specified amount of time in which the user can execute a reduced-ad version of the ad-associated app without monetary cost to the user. The method is executed by a processor.

In one embodiment, a system for managing a computer application (app) is disclosed. The system includes a plurality of servers for executing an ad-associated app and a reduced-ad version of the ad-associated app. One or more of the plurality of servers include logic for providing a notification of requirements to earn a reduced-ad reward to a user of the ad-associated app. One or more of the plurality of servers include logic for receiving data of monitored actions of the user to determine whether or not requirements to earn the reduced-ad reward are satisfied by the user. One or more of the plurality of servers include logic for providing the reduced-ad reward to the user of the ad-associated app upon determining that requirements to earn the reduced-ad reward are satisfied by the user. The reduced-ad reward is a specified amount of time in which the user can execute the reduced-ad version of the ad-associated app without monetary cost to the user.

In one embodiment, a computer implemented method for executing a computer application (app) is disclosed. The method includes providing requirements to earn a reduced-ad reward for the app on a display of a computing device of a user. The reduced-ad reward is a specified amount of time in which the user can execute the app with reduced advertisement display. The method also includes receiving data of monitored actions performed by the user on the computing device. The method also includes determining that the monitored actions performed by the user satisfy the requirements to earn the reduced-ad reward. The method further includes setting execution of a reduced-ad version of the app on the computing device of the user for the specified amount of time of the reduced-ad reward. Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 shows a flowchart of a method for executing a computer application (app), in accordance with one embodiment of the present invention.

FIG. 2 shows a table of example reduced-ad reward case implementations of the method of FIG. 1, in accordance with various embodiments of the present invention.

FIG. 3 shows a table of example applications of the various reduced-ad reward case implementations of FIG. 2, in accordance with various embodiments of the present invention.

FIG. 4 shows a flowchart of a computer implemented method for executing a computer application (app), in accordance with one embodiment of the present invention.

FIG. 5 shows a system for implementing the methods of FIGS. 1 through 4, in accordance with one embodiment of the present invention.

FIG. 6 shows a block diagram illustrating a social gaming network architecture for implementing the methods of FIGS. 1 through 4, in accordance with one embodiment of the present invention.

FIG. 7 illustrates an implementation of an online game infrastructure for implementing the methods of FIGS. 1 through 4, in accordance with one embodiment of the present invention.

FIG. 8 shows one embodiment of a Crew Mechanics in Multiplayer Games (hereinafter, “CMMG”) controller that can be utilized in conjunction with the methods of FIGS. 1 through 4, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

As used herein, the term “app” refers to any type of computer application that is executed by a computer processor of a computing device to generate graphical images and/or video associated with the app's execution on a display screen of the computing device, where the computing device can be of any type, including without limitation a desktop computer, a tablet computer, a laptop computer, a wearable computer, a portable device, a smart phone, a cell phone, a personal digital assistant, a computer equipped television, among others. In various embodiments, the app can be defined as a mobile app, a web app, a video game app, a music app, a global positioning system (GPS) app, a social networking app, a social-network-based video game app, or any type of app, or combination thereof. In some embodiments, the app can be contained and executed entirely on the computing device of the app user. In other embodiments, the app can be executed on a cloud computing system based on input signals received from the computing device of the app user, with graphical images associated with the app's execution transmitted from the cloud computing system to the display screen of the computing device of the app user. And, in some embodiments, the app can reside and execute partially on the computing device of the app user and partially on the cloud computing system, with reliance on communication of game data between the cloud computing system and the client device of the app user. Therefore, it should be understood that the term app as used herein refers to any type of computer application, including self-contained apps, mobile apps, and web apps, i.e., online apps.

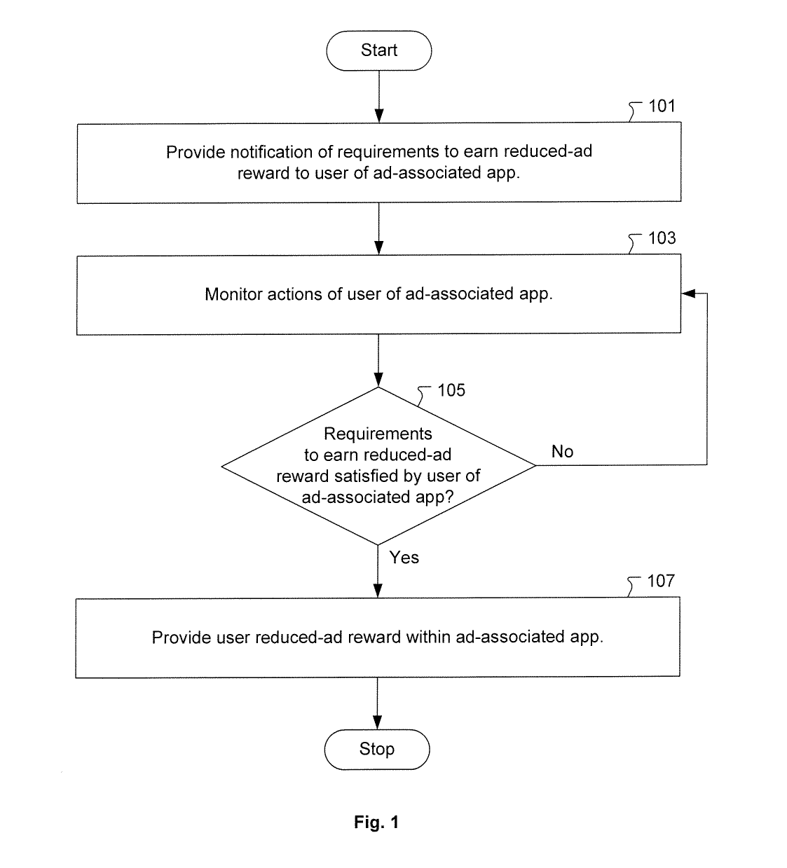

FIG. 1 shows a flowchart of a method for executing a computer application (app), in accordance with one embodiment of the present invention. In one embodiment, the method of FIG. 1 is a computer implemented method executed by a processor. Again, the app referred to in the method of FIG. 1 can be defined as a mobile app, a web app, a video game app, a music app, a global positioning system (GPS) app, a social networking app, a social-network-based video game app, or any type of app, or combination thereof. The app referred to in the method of FIG. 1 can exist in different versions, including an ad-associated version and a reduced-ad version. The ad-associated version of the app includes presentation of ads during a session of execution of the app. In various embodiments, the ads can be display ads, video ads, rich-media ads, pop-up ads, W2E, newsfeed ads, banner ads, interstitial or prestitial ads or any other ad-unit on web or mobile application, among others. In some embodiments, the ads can be displayed as overlays on the video generated by the app. Also, in some embodiments, the ads can be displayed in designated ad slots separate from the video generated by the app. Therefore, in various embodiments, the ads can be displayed: (a) alongside content of the app, or (b) integrated with content of the app, or (c) as a gating function of progression to one or more stages of the app, such as in a video game app, or (d) any combination of two or more of (a)-(c).

The ad-associated version of the app may be provided to a user free of charge, with the expectation of revenue from selling and displaying ads within and/or in conjunction with the app. A user of the ad-associated version of the app sacrifices the inconvenience, if any, of ad displays in exchange for executing the app free of charge. The reduced-ad app may be purchased at some cost by the user and provide the user with a reduced-ad experience. In various embodiments, the reduced-ad app reduces the amount of ads displayed within a range from zero ads to some amount of ads less than what is displayed with the ad-associated version of the app. In one embodiment, the reduced-ad app does not display any ads. In another embodiment, the reduced-ad app displays a same amount of ads as a paid version of the app.

In some embodiments, the ad-associated version and the reduced-ad version of the same app are defined as separate installations of the same app. In other embodiments, the ad-associated version and the reduced-ad version of the same app are provided through a common installation of the app in which a software setting is used to control how many ads are displayed and how often ads are displayed. In such embodiments, control over the software setting for ad display is exercised by a provider of the app and is not controllable by the user of the app.

The method of FIG. 1 occurs within the scenario of a user having an ad-associated version of an app installed on the user's computing device. Installation of the ad-associated version of the app, although free of charge, may require the user to provide registration information, such as the user's name, email address, cell phone number, or other identification and contact information. Therefore, in various embodiments of the method of FIG. 1, the provider of the ad-associated app will have contact information for the user to enable sending of messages or other content to the user. Also, in some embodiments, the ad-associated app includes social interactive operations between the user and friends of the user, via a social network.

The method includes an operation 101 for providing a notification of requirements to earn a reduced-ad reward to a user of an ad-associated app. The reduced-ad reward is a specified amount of time in which the user can execute a reduced-ad version of the ad-associated app without monetary cost to the user. It should be understood that monetary cost to the user refers to any required payment by the user. In various embodiments, the monetary cost may be defined as a required amount of real money/currency, virtual money/currency, tangible assets, virtual assets, or any combination thereof. Also, virtual assets may include game objects accumulated during prior execution of one or more apps.

In one embodiment, the reduced-ad version of the ad-associated app is the same app with the display of ads therein throttled under the control of the app provider. The app provider may transmit control signals from the cloud computing system to the user's computing device to effect throttling of the ad display within and/or in conjunction with the app. The specified amount of time in which the user can execute the reduced-ad version of the app can vary depending upon the extent of the requirements to earn the reduced-ad reward and how quickly the user satisfies the requirements. In some embodiments, the user may be granted a partial reduced-ad reward for completing a portion of the requirements necessary to earn the full reduced-ad reward.

In one embodiment, the notification of operation 101 is transmitted to the user during execution of the ad-associated app by the user. In one embodiment, the notification of operation 101 is transmitted to the user when the user is not executing the ad-associated app. In one embodiment, the notification of operation 101 is transmitted to the user through the ad-associated app itself. In one embodiment, the notification of operation 101 is transmitted to the user through a communication means outside of the ad-associated app, such as but not limited to email communication, text message (simple message system (SMS)), voice message, social network feed, display within web browser, prestitial display, push notification, etc.

In one embodiment, providing the notification of requirements to earn the reduced-ad reward in operation 101 includes displaying an ad within the ad-associated app, where the ad conveys the requirements to earn the reduced-ad reward. In another embodiment, providing the notification of requirements to earn the reduced-ad reward in operation 101 includes displaying a prestitial prior to display of a graphical image associated with execution of the ad-associated app, where the prestitial conveys the requirements to earn the reduced-ad reward. In another embodiment, providing the notification of requirements to earn the reduced-ad reward in operation 101 includes transmitting a push notification to the user, where the push notification conveys the requirements to earn the reduced-ad reward. In one instance of this embodiment, the push notification is an SMS message.

Following the operation 101, the method proceeds with an operation 103 for receiving data of monitored actions of the user to determine whether or not requirements to earn the reduced-ad reward are satisfied by the user. In one embodiment, the monitoring in operation 103 is linked to an account that is maintained for the user. The account can be defined to store information about a reduced-ad reward that has been offered to the user, when the reduced-ad reward was offered to the user, the requirements that the user must satisfy to receive the reduced-ad reward, and which requirements have been satisfied by the user and when they were satisfied. In some embodiments, the user logs into their user account to enable their actions to be monitored and linked to their user account. In other embodiments, the ad-associated app can include a module for monitoring the user's actions related to the requirements for earning the reduced-ad reward and linking to their user account. In other embodiments, an application can be installed and executed on the user's computing device to facilitate monitoring of the user's actions related to the requirements for earning the reduced-ad reward and linking to their user account. Also, in some embodiments, the corresponding app server on the cloud computing system monitors actions of the user. Additionally, it should be understood that the actions of the user related to earning the reduced-ad reward may occur while the user is playing the ad-associated app, while the user is participating in a social network activity, while the user is playing another app different from the ad-associated app, while the user is performing an activity not related to the ad-associated app, or any combination thereof, among others.

The method also includes an operation 105 for determining whether or not the requirements to earn the reduced-ad reward have been satisfied by the user of the ad-associated app. If operation 105 determines that the requirements have not been satisfied, the method reverts back to operation 103 to continue monitoring the actions of the user. If operation 105 determines that the requirements have been satisfied, the method continues with an operation 107 for providing the reduced-ad reward to the user of the ad-associated app. In one embodiment, granting of the reduced-ad reward to the user of the ad-associated app can include a provider of the ad-associated app setting a software control to temporarily convert the ad-associated app to the reduced-ad app, without requiring the user to install a separate reduced-ad version of the app. In another embodiment, the user is required to install a separate reduced-ad version of the app that is activated by the app provider for use during a limited period of time. In another embodiment, the app provider transmits control signals to the user's computing device to effect throttling of the ad display within and/or in conjunction with the ad-associated app.

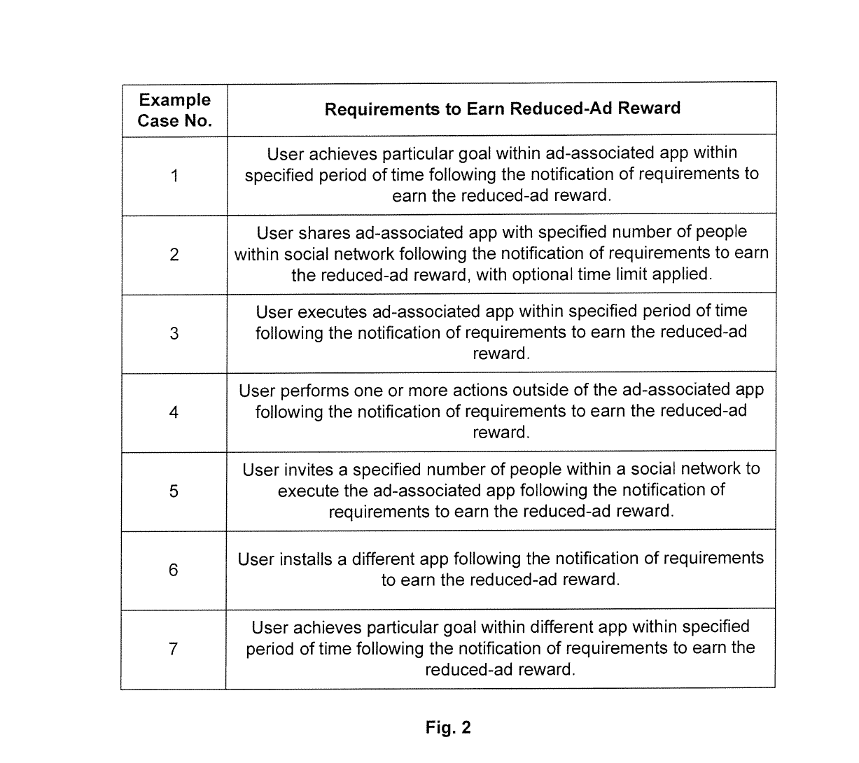

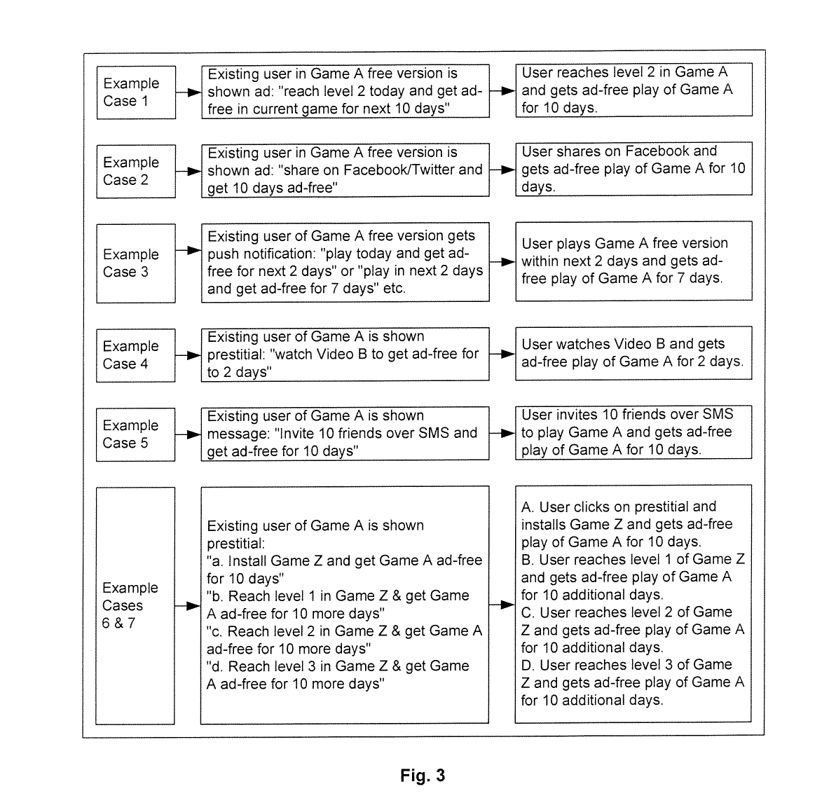

The method of FIG. 1 can be implemented in many different ways depending on the specification of the requirements to earn the reduced-ad reward and the specification of the reduced-ad reward. FIG. 2 shows a table of example reduced-ad reward case implementations of the method of FIG. 1, in accordance with various embodiments of the present invention. It should be understood that the example reduced-ad reward cases shown in FIG. 2 do not represent an all-inclusive set of reduced-ad reward cases. In other embodiments, the method of FIG. 1 can be performed to implement essentially any type of reduced-ad reward case beyond what is shown in FIG. 2. Also, FIG. 3 shows a table of example applications of the various reduced-ad reward case implementations of FIG. 2, in accordance with various embodiments of the present invention. It should be understood that the example applications of the various reduced-ad reward case implementation as shown in FIG. 3 are provided by way of example and are not intended to be limiting in any way.

FIG. 2 shows an example reduced-ad reward case 1 in which the requirements to earn the reduced-ad reward, as provided in the notification of operation 101, include a requirement that the user achieve a particular goal within the ad-associated app within a specified period of time following the providing of the notification of requirements to earn the reduced-ad reward to the user in operation 101. Reduced-ad reward case 1 encourages the user to spend more time executing the ad-associated app, thus increasing exposure of ads to the user. In one embodiment of the reduced-ad reward case 1, the particular goal is a specified level of advancement within the ad-associated app. In another embodiment of the reduced-ad reward case 1, the particular goal is an accumulation of a specified number of objects within the ad-associated app. In various embodiments, the specified number of objects include one or more of points, tokens, coins, game characters, game objects, and monetary items. FIG. 3 shows an example application of the reduced-ad reward case 1 in which an existing user of the ad-associated app (free version of Game A) is shown an ad that states “Reach level 2 today and get reduced-ad in current game for next 10 days.” Following this ad display, the user reaches level 2 in Game A within the day and gets reduced-ad play of Game A for 10 days.

FIG. 2 shows an example reduced-ad reward case 2 in which the requirements to earn the reduced-ad reward, as provided in the notification of operation 101, include a requirement that the user share the ad-associated app with a specified number of people within a social network, following the providing of the notification of requirements to earn the reduced-ad reward to the user in operation 101. Reduced-ad reward case 2 encourages the user to promote the ad-associated app to other users. In one embodiment, the requirement that the user share the ad-associated app with the specified number of people within the social network includes a time limit for completion of the requirement. In another embodiment, the requirement that the user share the ad-associated app with the specified number of people within the social network does not include a time limit for completion of the requirement. FIG. 3 shows an example application of the reduced-ad reward case 2 in which an existing user of the ad-associated app (free version of Game A) is shown an ad that states “Share on Facebook/Twitter and get 10 days reduced-ad.” Following this ad display, the user shares Game A on Facebook and gets reduced-ad play of Game A for 10 days.

FIG. 2 shows an example reduced-ad reward case 3 in which the requirements to earn the reduced-ad reward, as provided in the notification of operation 101, include a requirement that the user execute the ad-associated app within a specified period of time following the providing of the notification of requirements to earn the reduced-ad reward to the user in operation 101. Reduced-ad reward case 3 encourages the user to return to execute the app. FIG. 3 shows an example application of the reduced-ad reward case 3 in which an existing user of the ad-associated app (free version of Game A) receives a push notification that states “Play Game A in next 2 days and get reduced-ad play for 7 days.” Following this push notification, the user plays Game A within next 2 days and gets reduced-ad play of Game A for 7 days.

FIG. 2 shows an example reduced-ad reward case 4 in which the requirements to earn the reduced-ad reward, as provided in the notification of operation 101, include a requirement that the user perform one or more actions outside of the ad-associated app following the providing of the notification of requirements to earn the reduced-ad reward to the user in operation 101. Reduced-ad reward case 4 can be used to promote the app, or to promote another app, or to promote an item not related to the app. In one embodiment, the requirement that the user perform one or more actions outside of the ad-associated app includes a time limit for completion of the requirement. In another embodiment, the requirement that the user perform one or more actions outside of the ad-associated app does not include a time limit for completion of the requirement. FIG. 3 shows an example application of the reduced-ad reward case 4 in which an existing user of the ad-associated app (free version of Game A) is shown a prestitial that states “Watch Video B to get reduced-ad play for 2 days.” Following this prestitial display, the user watches Video B and gets reduced-ad play of Game A for 2 days.

FIG. 2 shows an example reduced-ad reward case 5 in which the requirements to earn the reduced-ad reward, as provided in the notification of operation 101, include a requirement that the user invite a specified number of people within a social network to execute the ad-associated app following the providing of the notification of requirements to earn the reduced-ad reward to the user in operation 101. Reduced-ad reward case 5 can be used to promote the app and increase exposure of ads displayed within the ad-associated version of the app. In one embodiment, the requirement that the user invite the specified number of people within the social network to execute the ad-associated app includes a time limit for completion of the requirement. In another embodiment, the requirement that the user invite the specified number of people within the social network to execute the ad-associated app does not include a time limit for completion of the requirement. FIG. 3 shows an example application of the reduced-ad reward case 5 in which an existing user of the ad-associated app (free version of Game A) is shown a message that states “Invite 10 friends over SMS and get reduced-ad play for 10 days.” Following this message, the user invites 10 friends over SMS to play Game A and gets reduced-ad play of Game A for 10 days.

FIG. 2 shows an example reduced-ad reward case 6 in which the requirements to earn the reduced-ad reward, as provided in the notification of operation 101, include a requirement that the user install a different app following the providing of the notification of requirements to earn the reduced-ad reward to the user in operation 101. Reduced-ad reward case 6 can be used to cross-promote different apps and increase exposure of ads displayed within the cross-promoted apps.

FIG. 2 shows an example reduced-ad reward case 7 in which the requirements to earn the reduced-ad reward, as provided in the notification of operation 101, include a requirement that the user achieve a particular goal within a different app. Reduced-ad reward case 7 may be linked with reduced-ad reward case 6 in which the different app is the same in both reduced-ad reward cases 6 and 7. Or, reduced-ad reward case 7 may be presented separately from reduced-ad reward case 6 based on knowing that the user has already installed the different app referenced in reduced-ad reward case 7. Reduced-ad reward case 6 can be used cross-promote apps, encourage execution of multiple apps, and increase exposure of ads displayed within the cross-promoted apps. In one embodiment of reduced-ad reward case 7, the particular goal is a specified level of advancement within the different app or an accumulation of a specified number of objects within the different app.

FIG. 3 shows an example application of reduced-ad reward cases 6 and 7 in which an existing user of the ad-associated app (free version of Game A) is shown a prestitial that states:
“a. Install Game Z and get Game A reduced-ad for 10 days.
b. Reach level 1 in Game Z and get Game A reduced-ad for 10 more days.
c. Reach level 2 in Game Z and get Game A reduced-ad for 10 more days.
d. Reach level 3 in Game Z and get Game A reduced-ad for 10 more days.”

Following this message, the following user actions and results occur:
A. User clicks on prestitial and installs Game Z and gets reduced-ad play of Game A for 10 days.
B. User reaches level 1 of Game Z and gets reduced-ad play of Game A for 10 additional days.
C. User reaches level 2 of Game Z and gets reduced-ad play of Game A for 10 additional days.
D. User reaches level 3 of Game Z and gets reduced-ad play of Game A for 10 additional days.

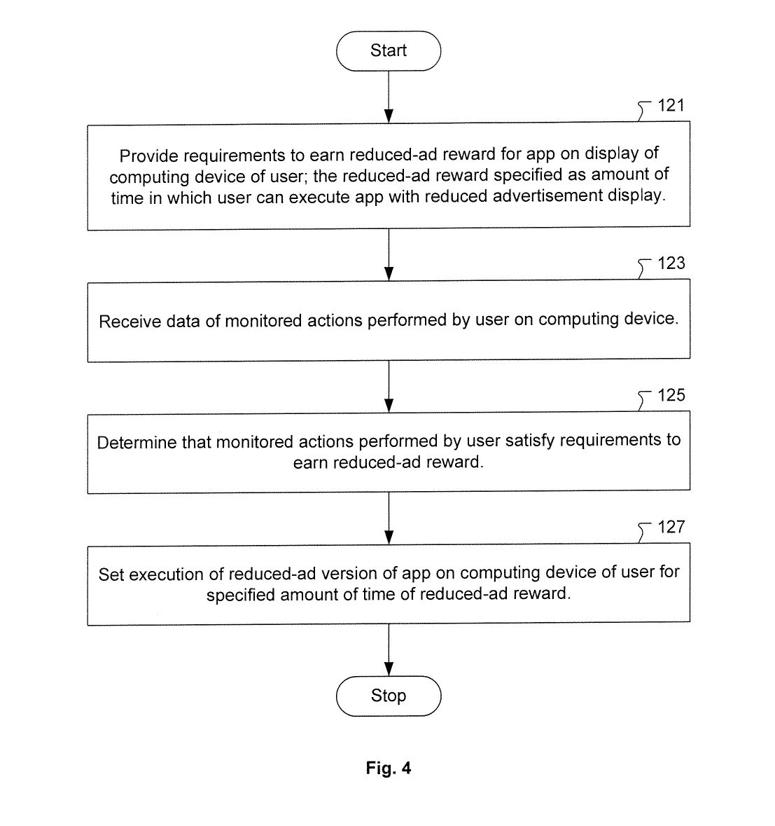

FIG. 4 shows a flowchart of a computer implemented method for executing a computer application (app), in accordance with one embodiment of the present invention. The method includes an operation 121 for providing requirements to earn a reduced-ad reward for the app on a display of a computing device of a user. The reduced-ad reward is a specified amount of time in which the user can execute the app with reduced advertisement display. In one embodiment, the reduced advertisement display of the reduce-ad reward is defined within a range extending from zero advertisement display to a pre-defined number of advertisement displays. In one instance of this embodiment, the pre-defined number of advertisement displays is equal to a number of advertisement displays that occur in conjunction with a paid version of the app. In one embodiment, the reduced advertisement display of the reduce-ad reward is zero advertisement display. Also, in one embodiment, the app is a social-network-based app. In one instance of this embodiment, the requirements to earn the reduced-ad reward for the app include actions required of the user within the social-network-based app. However, it should be understood that in other embodiments, the app is not a social-network-based app.

The method also includes an operation 123 for receiving data of monitored actions performed by the user on the computing device. The method also includes an operation 125 for determining that the monitored actions performed by the user satisfy the requirements to earn the reduced-ad reward. The method further includes an operation 127 for setting execution of a reduced-ad version of the app on the computing device of the user for the specified amount of time of the reduced-ad reward. It should be understood that the example reduced-ad reward case implementations described herein with regard to FIG. 2 are equally applicable for use with the method of FIG. 4. Specifically, the requirements to earn the reduced-ad reward for the app as provided in operation 121 can include any of the requirements listed for the example reduced-ad reward case implementations as shown in FIG. 2, among others.

Based on the foregoing, it should be appreciated that the methods of FIGS. 1 through 4 can be implemented to provide reduced-ad execution of an ad-associated app (free version of app) for a specified period of time as an incentive to improve user engagement with the app, drive new installs of the app by other users, cross-promote other apps, and encourage user engagement with other apps. Upon receipt of a reduced-ad reward, the temporarily activated reduced-ad version of the app can include a display marker indicating how much reduced-ad execution time of the app remains. Also, because ad display is generally used in free versions of apps, the methods of FIGS. 1 through 4 for reduced-ad rewards can be used for incentivized cross-promotion across many different apps. Additionally, the methods of FIGS. 1 through 4 can be adapted for and directed to specific classes of users, such as new users, occasional users, lost users, relapsed users, frequent users, among others. Also, the user in their life-time can be given multiple reduced-ad rewards on multiple occasions. And each time the reduced-ad reward time period ends, the user starts to see the ads again.

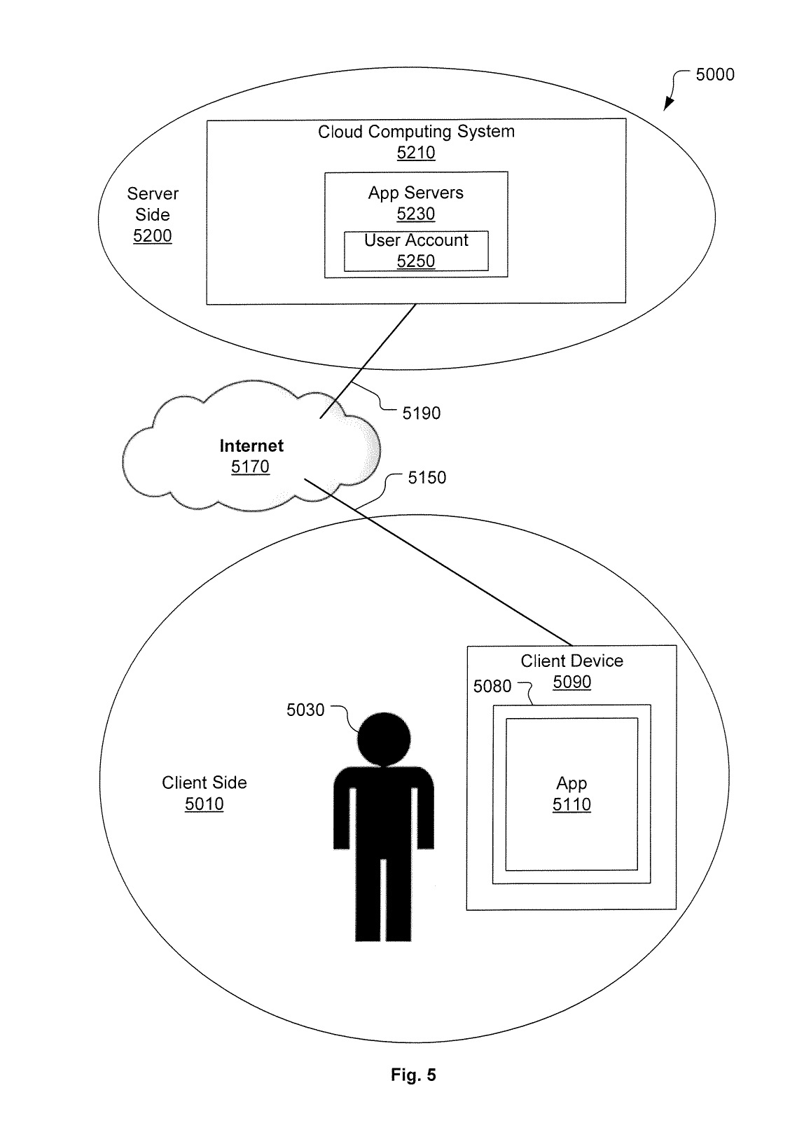

FIG. 5 shows a system 5000 for implementing the methods of FIGS. 1 through 4, in accordance with one embodiment of the present invention. It should be understood that any of the methods described herein with regard to FIGS. 1 through 4 can be executed using the system 5000. However, it should also be understood that the methods of FIGS. 1 through 4 can also be executed with systems that differ from the system 5000.

The system 5000 includes a client device 5090 executing a computer application (app) 5110 under the control of a user 5030. Video of the app 5110 is rendered on a display 5080 of the client device 5090. The client device 5090 can be any type of computing device properly equipped to execute the program instructions of the app and render a visual display of graphical images/video associated with execution of the app, such as a desktop computer, a laptop computer, a tablet computer, a smartphone, among others.

The client device 5090 is in communication with a cloud computing system 5210 through a network 5170, such as the Internet, as indicated by connections 5150 and 5190. The cloud computing system 5210 represents a server-side 5200 of the system 5000, with the client device 5090 and game player 5030 representing a client-side 5010 of the system 5000. The cloud computing system 5210 includes a plurality of servers 5230 for executing apps. One or more of the plurality of servers 5230 is/are defined to provide support and direction to the app 5110 executing on the client device 5090. In one embodiment, the app 5110 executes in conjunction with instructions received from at least one of the plurality of app servers 5230. At least one of the plurality of app servers 5230 can also include a user account 5250 for the user 5030. The user account 5250 can be defined to store profile data for the user 5030, such as identification and preferences of the user 5030, as well as parametric data associated with the user's execution of the app 5110. Also, in some instances, the user 5030 may be required to provide login credentials to the app server 5230 as part of initiating execution of the app 5110 and accessing the user account 5250 of the user 5030.

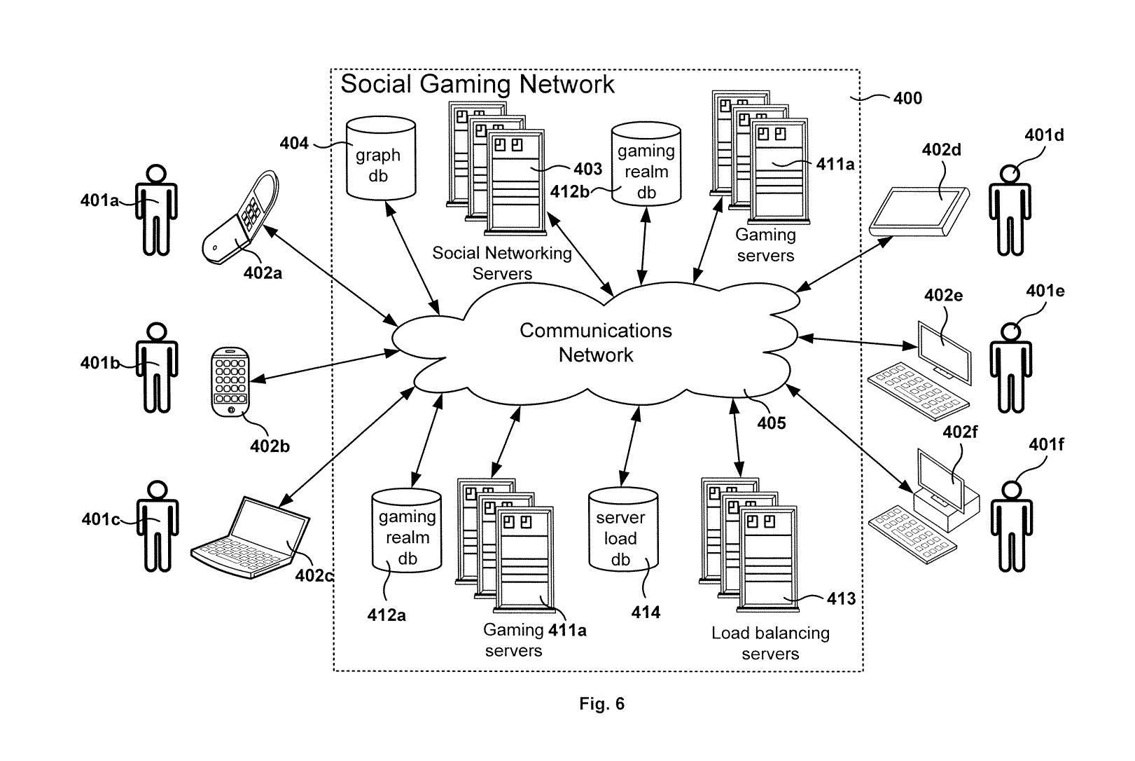

FIG. 6 shows a block diagram illustrating a social gaming network architecture for implementing the methods of FIGS. 1 through 4, in accordance with one embodiment of the present invention. In some implementations, a plurality of players (e.g., 401a-401f) may be utilizing a social gaming network 400. Each player interacts with the social gaming network via one or more client devices (e.g., client devices 402a-402f). The clients may communicate with each other and with other entities affiliated with the gaming platform via communications network 405. Further, the players may be utilizing a social networking service provided by a social networking server (e.g., social networking servers 403) to interact with each other.

When a player provides an input into the player's client device, the client device may in response send a message via the communications network to the social networking server. The social networking server may update the player profile, save the message to a database, send messages to other players, etc. The social gaming network may include a social graph database 404, which stores player relationships, social player profiles, player messages, and player social data.

The gaming servers host one or more gaming applications, and perform the computations necessary to provide the gaming features to the players and clients. One or more gaming realm databases (e.g., 412a-412b) store data related to the gaming services, such as the gaming applications and modules, virtual gaming environment (“realm”) data, player gaming session data, player scores, player virtual gaming profiles, game stage levels, etc. The gaming servers may utilize the data from the gaming realm databases to perform the computations related to providing gaming services for the players. In some implementations, a server load database 414b stores gaming server load statistics, such as computational load, server responses times, etc. The social gaming network may include a load balancing server 413.

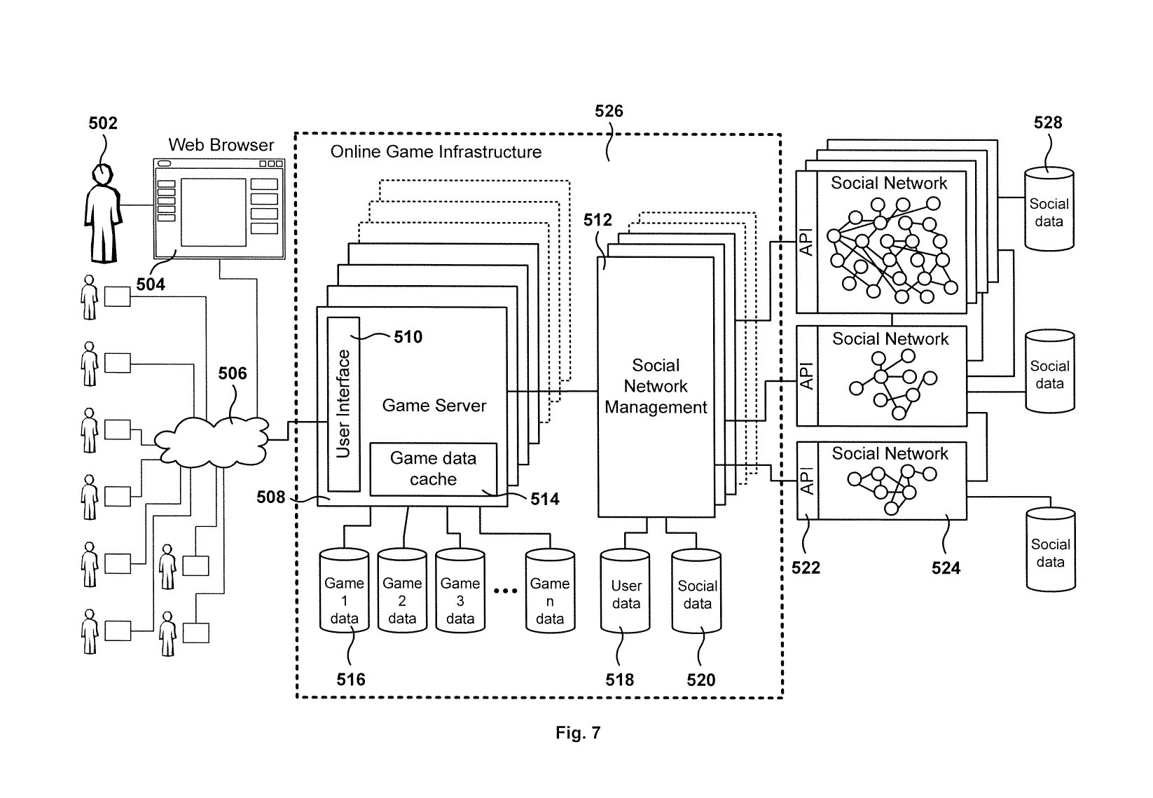

FIG. 7 illustrates an implementation of an online game infrastructure for implementing the methods of FIGS. 1 through 4, in accordance with one embodiment of the present invention. The online game infrastructure 526 includes one or more game servers 508, web servers (not shown), one or more social network management servers 512, and databases to store game related information. In one embodiment, game server 508 provides a user interface 510 for players 502 to play the online game. In one embodiment, game server 508 includes a Web server for players 502 to access the game via web browser 504, but the Web server may also be hosted in a server different from game server 508. Network 506 interconnects players 502 with the one or more game servers 508.

Each game server 508 has access to one or more game databases 516 for keeping game data. In addition, a single database can store game data for one or more online games. Each game server 508 may also include one or more levels of caching. Game data cache 514 is a game data cache for the game data stored in game databases 516. For increased performance, caching may be performed in several levels of caching.

The number of game servers 508 changes over time, as the gaming platform is an extensible platform that changes the number of game servers according to the load on the gaming infrastructure. As a result, the number of game servers will be higher during peak playing times, and the number of game servers will be lower during off-peak hours.

One or more social network management servers 512 provide support for the social features incorporated into the online games. The social network management servers 512 access social data 528 from one or more social networks 524 via Application Programming Interfaces (API) 522 made available by the social network providers. Each social network 524 includes social data 528, and this social data 528, or a fraction of the social data, is made available via API 522. As in the case of the game servers, the number of social network management servers 512 that are active at a point in time changes according to the load on the infrastructure. As the demand for social data increases, the number of social network management servers 512 increases. Social network management servers 512 cache user data in database 518, and social data in database 520. The social data might include the social networks where a player is present, the social relationships for the player, the frequency of interaction of the player with the social network and with other players, etc. Additionally, the user data kept in database 518 may include the player's name, demographics, e-mail, games played, frequency of access to the game infrastructure, etc.

It is noted that the embodiment illustrated in FIG. 7 is an exemplary online gaming infrastructure. Other embodiments may utilize different types of servers, databases, APIs, etc., and the functionality of several servers can be provided by a single server, or the functionality can be spread across a plurality of distributed servers. The embodiment illustrated in FIG. 7 should therefore not be interpreted to be exclusive or limiting, but rather exemplary or illustrative.

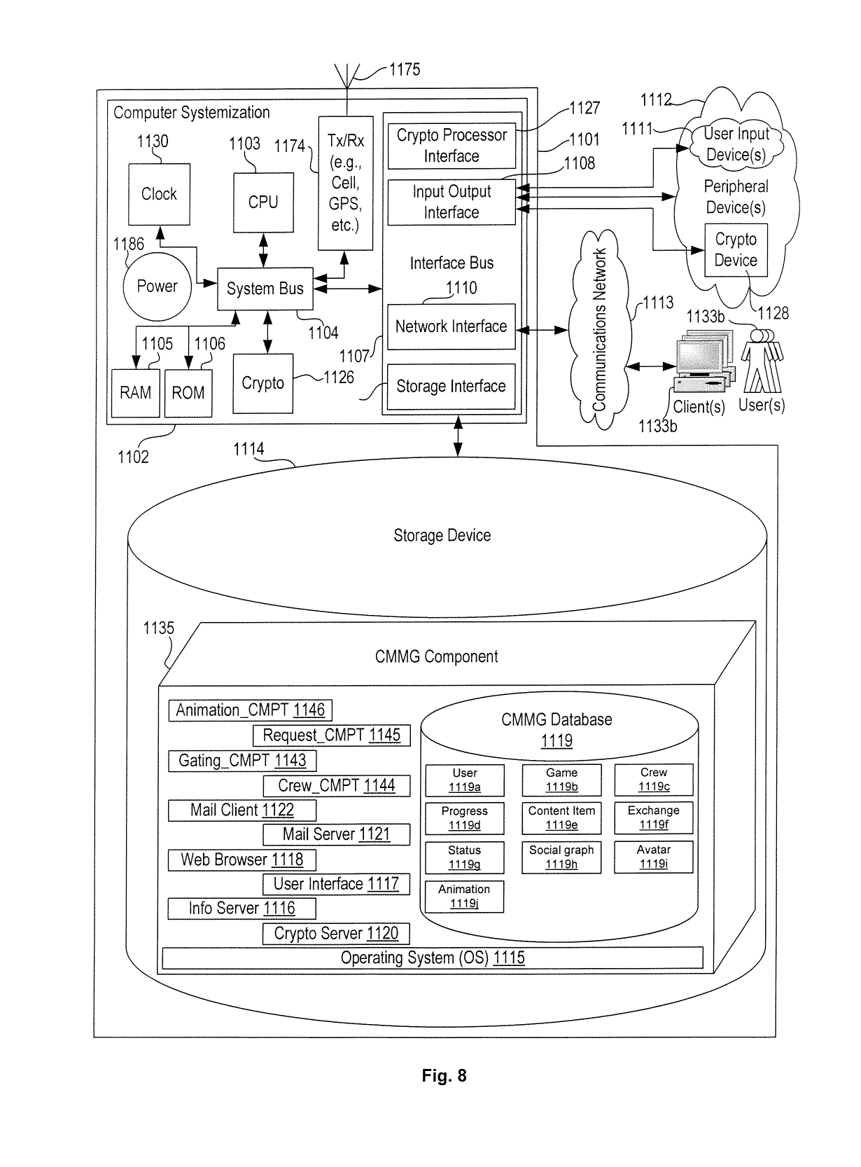

FIG. 8 shows one embodiment of a Crew Mechanics in Multiplayer Games (hereinafter, “CMMG”) controller 1101 that can be utilized in conjunction with the methods of FIGS. 1 through 4, in accordance with one embodiment of the present invention. In this embodiment, the CMMG controller 1101 may serve to aggregate, process, store, search, serve, identify, instruct, generate, match, and/or facilitate interactions with a computer through software, listing service and financial management technologies, and/or other related data.

Users may engage information technology (e.g., computers) to facilitate information processing. In turn, computers employ processors to process information; such processors 1103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed include: input and output mechanisms through which data may pass into and out of a computer; memory storage into which data may be saved; and processors by which information may be processed. These information technology resources may be used to collect data for later retrieval, analysis, and manipulation, which may be facilitated through a database program.

In one embodiment, the CMMG controller 1101 may be connected to and/or communicate with: a processor 1103 or central processing unit (“CPU”); one or more users from user input devices 1111; peripheral devices 1112; an optional cryptographic processor device 1128; and/or a communications network 1113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers and/or clients across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CMMG controller 1101 may be based on a computer systemization 1102 connected to the CMMG component 1135. The CMMG controller 1101 transforms in game status of a user's social content item via CMMG components into a content item with layered integration of additional content indicative of status. In one embodiment, the CMMG component may include a gating_component 1143 and a crew_component 1144. In one embodiment, the CMMG component may further include a request_component 1145 and an animation component 1146. Depending on the implementation, one or more of the noted components may operate on a dedicated server, performed through an associated cloud service or by using a hybrid cloud technique. The hybrid cloud technique may include using platform-oriented and/or service-oriented cloud architectures in combination with a dedicated server.

A computer systemization 1102 may comprise a clock 1130, central processing unit (“CPU(s)” and/or “processor(s)” (these terms are used interchangeable throughout the disclosure unless noted to the contrary)) 1103, a memory (e.g., a read only memory (ROM) 1106, a random access memory (RAM) 1104, etc.), and/or an interface bus 1107. These components may be interconnected and/or communicating through a system bus 1104 on one or more (mother)board(s) 1102 having conductive and/or otherwise transportive circuit pathways through which instructions (e.g., binary encoded signals) may travel to effectuate communications, operations, storage, etc. The computer systemization may be connected to a power source 1186. The power source may be external or internal to the respective computer systemization. A cryptographic processor 1126 and/or transceivers (e.g., ICs) 1174 may be connected to the system bus. In another embodiment, the cryptographic processor and/or transceivers may be connected as either internal and/or external peripheral devices 1112 via the interface bus I/O. The transceivers may be connected to antenna(s) 1175, thereby effectuating wireless transmission and reception of various communication and/or sensor protocols. For example, the antenna(s) may connect to: a Texas Instruments WiLink WL1283 transceiver chip (e.g., providing 802.11n, Bluetooth 3.0, FM, global positioning system (GPS) (thereby allowing CMMG controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies XGold 618-PMB9800 (e.g., providing 2G/3G HSDPA/HSUPA communications); and/or the like. The system clock may include a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization may drive signals embodying information. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in some embodiments, any of the above components may be connected directly to one another, connected to the CPU, and/or organized in numerous variations.

The CPU may comprise data processor adequate to execute program components for executing user and/or CMMG-generated requests. A processor may include specialized processing units. For example, a processor may include integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to data processing techniques. Such instruction passing facilitates communication within the CMMG controller and beyond through various interfaces. Should processing requirements dictate a greater amount speed and/or capacity, distributed processors (e.g., Distributed CMMG), mainframe, multi-core, parallel, and/or super-computer architectures may similarly be employed. Alternatively, should deployment requirements dictate greater portability, smaller Personal Digital Assistants (PDAs) may be employed.

Features of the CMMG may be achieved by implementing a microcontroller such as CAST's R8051XC2 microcontroller; Intel's MCS 51 (i.e., 8051 microcontroller); and/or the like. Some feature implementations may include embedded components, such as: Application-Specific Integrated Circuit (“ASIC”), Digital Signal Processing (“DSP”), Field Programmable Gate Array (“FPGA”), and/or the like embedded technology. For example, any of the CMMG component collection (distributed or otherwise) and/or features may be implemented via the microprocessor and/or via embedded components; e.g., via ASIC, coprocessor, DSP, FPGA, and/or the like. Alternately, some implementations of the CMMG may be implemented with embedded components that are configured and used to achieve a variety of features or signal processing.

The embedded components may include software solutions, hardware solutions, and/or some combination of both hardware/software solutions. For example, CMMG features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects may be programmed by the customer or designer to implement the CMMG features. A hierarchy of programmable interconnects allow logic blocks to be interconnected as needed by the CMMG administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. The CMMG may be developed on FPGAs and/or migrated into a fixed version that more resembles ASIC implementations. Alternate or coordinating implementations may migrate CMMG controller features to a final ASIC instead of or in addition to FPGAs. Embedded components and microprocessors may be considered the “CPU” and/or “processor” for the CMMG.

The power source 1186 may be of any form for powering electronic circuit board devices. Power cells may include alkaline, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1186 may be connected to at least one of the interconnected subsequent components of the CMMG platform thereby providing an electric current to all subsequent components. In one example, the power source 1186 is connected to the system bus component 1104.An outside power source 1186 may be connected across the I/O 1108 interface. For example, a USB and/or IEEE 1394 connection carries both data and power across the connection and is therefore a suitable source of power.

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters may connect to the interface bus via a slot architecture. Some slot architectures may include: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the CMMG controller is accessible through remote clients 1133b (e.g., computers with web browsers) by users 1133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed CMMG), architectures may similarly be employed to pool, load balance, and/or otherwise increase the communicative bandwidth required by the CMMG controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 410 may be used to engage with various communications network types 1113. For example, multiple network interfaces may be employed to allow for the communication over broadcast, multicast, and/or unicast networks.

Input Output interfaces (I/O) 1108 may accept, communicate, and/or connect to user input devices 1111, peripheral devices 1112, cryptographic processor devices 1128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1111 often are a type of peripheral device 1112 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1112 may be connected and/or communicate to I/O and/or other facilities of the like such as network interfaces, storage interfaces, directly to the interface bus, system bus, the CPU, and/or the like. Peripheral devices may be external, internal and/or part of the CMMG controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 1128), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the CMMG controller may be embodied as an embedded, dedicated, and/or monitor-less (i.e., headless) device, wherein access would be provided over a network interface connection.

Cryptographic units such as, but not limited to, microcontrollers, processors 1126, interfaces 1127, and/or devices 1128 may be attached, and/or communicate with the CMMG controller. A MC68HC16 microcontroller, manufactured by Motorola Inc., may be used for and/or within cryptographic units. The MC68HC 16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the CMMG controller and/or a computer systemization may employ various forms of memory. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory will include ROM 1106, RAM 1105, and a storage device 1114. A storage device 1114 may be any conventional computer storage. Storage devices may include a (fixed and/or removable) magnetic disk drive; a magneto-optical drive; an optical drive (i.e., Bluray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

The memory may contain a collection of program and/or database components and/or data such as, but not limited to: operating system component(s) 1115 (operating system); information server component(s) 1116 (information server); user interface component(s) 1117 (user interface); Web browser component(s) 1118 (Web browser); database(s) 1119; mail server component(s) 1121; mail client component(s) 1122; cryptographic server component(s) 1120 (cryptographic server); the CMMG component(s) 1135; and/or the like (i.e., collectively a component collection). These components may be stored and accessed from the storage devices and/or from storage devices accessible through an interface bus. Although nonconventional program components such as those in the component collection, typically, are stored in a local storage device 1114, they may also be loaded and/or stored in memory such as: peripheral devices, RAM, remote storage facilities through a communications network, ROM, various forms of memory, and/or the like.

The operating system component 1115 is an executable program component facilitating the operation of the CMMG controller. Typically, the operating system facilitates access of I/O, network interfaces, peripheral devices, storage devices, and/or the like. The operating system may be a highly fault tolerant, scalable, and secure such as: Apple Macintosh OS X (Server); AT&T Plan 9; Be OS; Unix and Unix like distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. Other operating systems may also be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the CMMG controller to communicate with other entities through a communications network 1113. Various communication protocols may be used by the CMMG controller as a subcarrier transport mechanism for interaction, such as, but not limited to: multicast, TCP/IP, UDP, unicast, and/or the like.

An information server component 1116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP),WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CMMG controller based on the remainder of the HTTP request. For example, a request such as http://123.124.125.126/myInformation.html ght have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CMMG database 1119, operating systems, other program components, user interfaces, Web browsers, and/or the like.

Access to the CMMG database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CMMG. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CMMG as a query. Upon generating query results from the query, the results are passed over the bridge mechanism, and may be parsed for formatting and generation of new results Web page by the bridge mechanism. Such a new results Web page is then provided to the information server, which may supply it to the requesting Web browser. Also, an information server may contain, communicate, generate, obtain, and/or provide program component, user, and/or data communications, requests, and/or responses.

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, HTML5, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components through textual and/or graphical facilities. The user interface provides a facility through which users may affect, interact, and/or operate a computer. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, user, and/or data communications, requests, and/or responses.

A Web browser component 1118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, HTML5, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, user, and/or data communications, requests, and/or responses. Also, in place of a Web browser and information server, a combined application may be developed to perform similar operations of both. The combined application would similarly affect the obtaining and the provision of information to users, user agents, and/or the like from the CMMG enabled nodes.

A mail server component 1121 is a stored program component that is executed by a CPU 1103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the CMMG. Access to the CMMG mail may be achieved through a number of APIs offered by the individual Web server components and/or the operating system. Also, a mail server may contain, communicate, generate, obtain, and/or provide program component, user, and/or data communications, requests, information, and/or responses.

A mail client component 1122 is a stored program component that is executed by a CPU 1103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, user, and/or data communications, requests, information, and/or responses. Generally, the mail client provides a facility to compose and transmit electronic mail messages.

A cryptographic server component 1120 may include a stored program component that is executed by a CPU 1103, cryptographic processor 1126, cryptographic processor interface 1127, cryptographic processor device 1128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component is operable to facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the CMMG may encrypt all incoming and/or outgoing communications and may serve as node within a virtual private network (VPN) with a wider communications network. The cryptographic component is operable to facilitate the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the CMMG component to engage in secure transactions if so desired. The cryptographic component facilitates the secure accessing of resources on the CMMG and facilitates the access of secured and/or remote resources For example, the cryptographic component may act as a client and/or server of secured resources. In one embodiment, the cryptographic component communicates with information servers, operating systems, other program components, and/or the like. The cryptographic component may contain, communicate, generate, obtain, and/or provide program component, user, and/or data communications, requests, and/or responses.

The CMMG database component 1119 may be embodied in a database and its stored data. The database may include a stored program component, which may be executed by the CPU; the stored program component portion configuring the CPU to process the stored data. The database may be a conventional, fault tolerant, relational, scalable, secure database such as Oracle or Sybase. Relational databases may include extensions of a flat file(s). Relational databases may comprise a series of related tables. In some embodiments, the tables may be interconnected or associated via a key field. Use of the key field allows the combination of the tables by indexing against the key field; i.e., the key fields act as dimensional pivot points for combining information from various tables. Relationships generally identify links maintained between tables by matching primary keys. Primary keys may represent fields that uniquely identify the rows of a table in a relational database. More precisely, they uniquely identify rows of a table on the “one” side of a one-to-many relationship.

In one embodiment, the CMMG database may be implemented using various standard data-structures, such as an array, hash, (linked) list, structured document or text file (e.g., XML), table, and/or the like. Such data-structures may be stored in memory and/or in (structured) files. In one embodiment, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases where objects may include encapsulated capabilities. If the CMMG database is implemented as a data-structure, the use of the CMMG database 1119 may be integrated into another component such as the CMMG component 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1119 includes several tables 1119a-f. A user table 1119a includes fields such as, but not limited to: user name, user identifier, user crew and/or the like. The user table may support and/or track multiple user accounts on the CMMG platform. A game table 1119b includes fields such as, but not limited to: game_identifier, game_type and/or the like. The game table may support and/or track multiple game accounts on the CMMG platform. A crew table 1119c includes fields such as, but not limited to: crew_identifier, crew_type, crew_sector, crew_goal and/or the like. The crew table may support and/or track multiple crew on the CMMG platform. A progress table 1119d includes fields such as, but not limited to: progress_identifier, progress_associations, progress_index and/or the like. The progress table may support and/or track multiple progress bars on the CMMG platform. A content_item 1119e includes fields such as, but not limited to: content_item_identifier, content_item_associations, content_item_type, content_item_price, content_item_progress, content_item_analytics and/or the like. The content_item table may support and/or track multiple content_item accounts on the CMMG platform.

An exchange 1119f includes fields such as, but not limited to: exchange_identifier, exchange_type, exchange_routing_number, exchange_bank, exchange_credits, exchange_transfer, exchange_deposit_account and/or the like. The exchange table may support and/or track multiple exchange accounts on the CMMG platform. A status 1119g includes fields such as, but not limited to: status_identifier, status_type, status_user, status_crew, status_feed and/or the like. The status table may support and/or track multiple framework accounts on the CMMG platform. A social graph 1119h includes fields such as, but not limited to: social_graph_identifier, social_graph_associations, social_graph_status, social_graph_analytics and/or the like. The social graph table may support and/or track multiple social graphs on the CMMG platform. An avatar table 1119i includes fields such as, but not limited to: avatar_identifier, avatar_type, avatar_status, avatar_associations, avatar_modifications and/or the like. The avatar table may support and/or track multiple avatars on the CMMG platform. An animation table 1119j includes fields such as, but not limited to: animation_{—} identifier, animation_type, animation_associations and/or the like. The animation table may support and/or track multiple animations on the CMMG platform.

In one embodiment, the CMMG database may interact with other databases. For example, employing a distributed database, queries and data access by search CMMG component may treat the combination of the CMMG database, an integrated data security layer database as a single database entity.

In one embodiment, user programs may contain various user interface primitives, which may serve to update the CMMG. Also, various accounts may require custom database tables depending upon the environments and the types of clients the CMMG may need to serve. It should be noted that any unique fields may be designated as a key field throughout. In an alternative embodiment, these tables have been decentralized into their own databases and their respective database controllers (i.e., individual database controllers for each of the above tables). Employing advantageous data processing techniques, one may further distribute the databases over several storage devices. Similarly, configurations of the decentralized database controllers may be varied by consolidating and/or distributing the various database components 1119. The CMMG may be configured to keep track of various settings, inputs, and parameters via database controllers.

The CMMG database may communicate to and/or with other components in a component collection, including itself, and/or facilities of the like. Most frequently, the CMMG database communicates with the CMMG component, other program components, and/or the like. The database may contain, retain, and provide information regarding other nodes and data.

The CMMG component 1135 is a stored program component that is executed by a CPU. In one embodiment, the CMMG component incorporates any and/or all combinations of the aspects of the CMMG that was discussed in the previous figures. As such, the CMMG affects accessing, obtaining and the provision of information, services, transactions, and/or the like across various communications networks. In one embodiment, the CMMG platform transforms in game status of a user's social content item, via CMMG components 1135 into a content item with layered integration of additional content indicative of status.

The CMMG component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; HTML5; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the CMMG server employs a cryptographic server to encrypt and decrypt communications. The CMMG component may communicate to and/or with other components in a component collection, including itself, and/or facilities of the like. Most frequently, the CMMG component communicates with the CMMG database, operating systems, other program components, and/or the like. The CMMG may contain, communicate, generate, obtain, and/or provide program component, user, and/or data communications, requests, and/or responses.

The structure and/or operation of any of the CMMG node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through advantageous data processing communication techniques.

The configuration of the CMMG controller may depend on the context of implementation. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.: w3c -post http:// . . . Value1, where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of implementation.

For example, in some implementations, the CMMG controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database.

It should be understood that any method operations disclosed herein can involve execution of computer-executable instructions by software written or otherwise expressed in any suitable programming language or combination of programming languages. In various embodiments, software is expressed as source code or object code. In various embodiments, software is expressed in a higher-level programming language, such as, for example, C, Pert, or a suitable extension thereof. In various embodiments, software is expressed in a lower-level programming language, such as assembly language (or machine code). In various embodiments, software is expressed in JAVA. In various embodiments, software is expressed in Hyper Text Markup Language (HTML), Extensible Markup Language (XML), or other suitable markup language.

It should be further understood that any software for performing any of the operations of the various methods disclosed herein can be recorded as computer readable code on a non-transitory computer-readable storage medium. The non-transitory computer readable storage medium is any data storage device that can store data which can be thereafter be read by a computer system. Examples of non-transitory computer readable storage media include hard drives, network attached storage (NAS), read-only memory, random-access memory, CD-ROMs, CD-Rs, CD-RWs, magnetic tapes, and other optical and non-optical data storage devices. The computer readable code can also be distributed over a network of coupled computer systems so that the computer readable code is stored and executed in a distributed fashion.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention.

What is claimed is:

1. A computer implemented method for executing a computer application (app), comprising:
providing a notification of requirements to earn a reduced-ad reward to a user of an ad-associated app;
receiving data of monitored actions of the user to determine whether or not requirements to earn the reduced-ad reward are satisfied by the user; and
upon determining that requirements to earn the reduced-ad reward are satisfied by the user, providing the reduced-ad reward to the user of the ad-associated app, wherein the reduced-ad reward is a specified amount of time in which the user can execute a reduced-ad version of the ad-associated app without monetary cost to the user, the method being executed by a processor.

2. The computer implemented method for executing the app as recited in claim 1, wherein providing the notification of requirements to earn the reduced-ad reward includes displaying an advertisement within the ad-associated app, wherein the advertisement conveys the requirements to earn the reduced-ad reward.

3. The computer implemented method for executing the app as recited in claim 1, wherein providing the notification of requirements to earn the reduced-ad reward includes displaying a prestitial prior to display a graphical image associated with the ad-associated app, wherein the prestitial conveys the requirements to earn the reduced-ad reward.

4. The computer implemented method for executing the app as recited in claim 1, wherein providing the notification of requirements to earn the reduced-ad reward includes transmitting a push notification to the user, wherein the push notification conveys the requirements to earn the reduced-ad reward.

5. The computer implemented method for executing the app as recited in claim 4, wherein the push notification is a simple message system (SMS) message.

6. The computer implemented method for executing the app as recited in claim 1, wherein the requirements to earn the reduced-ad reward include a requirement that the user achieve a particular goal within the ad-associated app within a specified period of time following the providing of the notification of requirements to earn the reduced-ad reward to the user.

7. The computer implemented method for executing the app as recited in claim 6, wherein the particular goal is a specified level of advancement within the ad-associated app.

8. The computer implemented method for executing the app as recited in claim 6, wherein the particular goal is an accumulation of a specified number of objects within the ad-associated app.

9. The computer implemented method for executing the app as recited in claim 8, wherein the specified number of objects include one or more of points, tokens, coins, game characters, game objects, and monetary items.

10. The computer implemented method for executing the app as recited in claim 1, wherein the requirements to earn the reduced-ad reward include a requirement that the user share the ad-associated app with a specified number of people within a social network following the providing of the notification of requirements to earn the reduced-ad reward to the user.

11. The computer implemented method for executing the app as recited in claim 10, wherein the requirement that the user share the ad-associated app with the specified number of people within the social network includes a time limit for completion of the requirement.

12. The computer implemented method for executing the app as recited in claim 1, wherein the requirements to earn the reduced-ad reward include a requirement that the user execute the ad-associated app within a specified period of time following the providing of the notification of requirements to earn the reduced-ad reward to the user.

13. The computer implemented method for executing the app as recited in claim 1, wherein the requirements to earn the reduced-ad reward include a requirement that the user perform one or more actions outside of the ad-associated app following the providing of the notification of requirements to earn the reduced-ad reward to the user.

14. The computer implemented method for executing the app as recited in claim 13, wherein the requirement that the user perform one or more actions outside of the ad-associated app includes a time limit for completion of the requirement.

15. The computer implemented method for executing the app as recited in claim 1, wherein the requirements to earn the reduced-ad reward include a requirement that the user invite a specified number of people within a social network to execute the ad-associated app following the providing of the notification of requirements to earn the reduced-ad reward to the user.

16. The computer implemented method for executing the app as recited in claim 15, wherein the requirement that the user invite the specified number of people within the social network to execute the ad-associated app includes a time limit for completion of the requirement.

17. The computer implemented method for executing the app as recited in claim 1, wherein the requirements to earn the reduced-ad reward include a requirement that the user install a different app following the providing of the notification of requirements to earn the reduced-ad reward to the user.

18. The computer implemented method for executing the app as recited in claim 17, wherein the requirements to earn the reduced-ad reward further include a requirement that the user achieve a particular goal within the different app.

19. The computer implemented method for executing the app as recited in claim 18, wherein the particular goal is a specified level of advancement within the different app or an accumulation of a specified number of objects within the different app.

20. The computer implemented method for executing the app as recited in claim 1, wherein the app is defined as a mobile app, a web app, a video game app, a music app, a global positioning system (GPS) app, a social networking app, a social-network-based video game app, or a combination thereof.

21. The computer implemented method for executing the app as recited in claim 1, wherein the reduced-ad version of the ad-associated app includes display of a number of advertisements within a range extending from zero advertisement display to a pre-defined number of advertisement displays.

22. The computer implemented method for executing the app as recited in claim 21, wherein the pre-defined number of advertisement displays is equal to a number of advertisement displays that occur in conjunction with a paid version of the app.

23. The computer implemented method for executing the app as recited in claim wherein the reduced-ad version of the ad-associated app has zero advertisement display.

24. A system for managing a computer application (app), comprising:
a plurality of servers for executing an ad-associated app and a reduced-ad version of the ad-associated app, wherein one or more of the plurality of servers include logic for,
providing a notification of requirements to earn a reduced-ad reward to a user of the ad-associated app;
receiving data of monitored actions of the user to determine whether or not requirements to earn the reduced-ad reward are satisfied by the user; and
upon determining that requirements to earn the reduced-ad reward are satisfied by the user, providing the reduced-ad reward to the user of the ad-associated app, wherein the reduced-ad reward is a specified amount of time in which the user can execute the reduced-ad version of the ad-associated app without monetary cost to the user.

25. A computer implemented method for executing a computer application (app), comprising:
providing requirements to earn a reduced-ad reward for the app on a display of a computing device of a user, wherein the reduced-ad reward is a specified amount of time in which the user can execute the app with reduced advertisement display;
receiving data of monitored actions performed by the user on the computing device; and
determining that the monitored actions performed by the user satisfy the requirements to earn the reduced-ad reward; and
setting execution of a reduced-ad version of the app on the computing device of the user for the specified amount of time of the reduced-ad reward.

26. The computer implemented method for executing the app as recited in claim 25, wherein the reduced advertisement display of the reduce-ad reward is defined within a range extending from zero advertisement display to a pre-defined number of advertisement displays.

27. The computer implemented method for executing the app as recited in claim 26, wherein the pre-defined number of advertisement displays is equal to a number of advertisement displays that occur in conjunction with a paid version of the app.

28. The computer implemented method for executing the app as recited in claim 25, wherein the app is a social-network-based video game.

29. The computer implemented method for executing the app as recited in claim 28, wherein the requirements to earn the reduced-ad reward for the app include actions required of the user within the social-network-based video game.
